(19) United States
(12) Patent Application Publication
(10) Pub. No.: US 2024/0296480 A1
(43) Pub. Date: Sep. 5, 2024

(54) METHODS AND APPARATUS FOR GENERATING CUSTOM CONTENT RESPONSIVE TO A RECEIVED SEARCH QUERY

(71) Applicant: GOOGLE LLC, Mountain View, CA (US)

(72) Inventors: Boris Dadachev, Mountain View, CA (US); Kishore Papineni, Mountain View, CA (US); Siva Kumar Gorantla, Mountain View, CA (US); Levent Koc, Mountain View, CA (US)

(21) Appl. No.: 18/573,371

(22) PCT Filed: May 26, 2022
(86) PCT No.: PCT/US22/31206

§ 371 Date: Dec. 21, 2023

(51) Int. Cl. G06Q 30/0251; G06Q 30/0241

(52) U.S. Cl. CPC G06Q 30/0256; G06Q 30/0276; G06Q 30/0277

(57) ABSTRACT

Example methods, apparatus, and systems for generating custom content responsive to a received search query are disclosed. An example method for generating custom content responsive to a received search query includes receiving, via a communication interface from a user computing device, a search query including one or more search terms; determining, responsive to the search query, a set of search results relevant to the search query; identifying, responsive to the search query, third-party content and/or a third party relevant to the search query; generating, based on (i) the search query and (ii) the third-party content or the third party, custom content relevant to the search query and related to a landing page associated with the third-party content or the third party, for presentation along with the set of research results; and transmitting, via the communication interface to the user computing device, the custom content.

### FIELD OF TECHNOLOGY

This disclosure relates generally to search queries, and, more particularly, to methods and apparatus for generating custom content responsive to a received search query.

### BACKGROUND

Responsive to a received search query received from a user computing device, a search engine may identify one or more search results (e.g., websites) relevant to the search query, and return the search results to the user computing device, which can present the search results for a user.

In some cases, a system in which the search engine operates can provide additional content in addition to the search results. For example, a third party can generate certain content for the system to display along with the search results, when the third-party content is relevant to the search results. The system in this case needs to accurately and efficiently match third-party content to search results.

### SUMMARY

Generally speaking, the system of this disclosure can automatically modify third-party content made up of certain terms by replacing, adding, or removing some of these terms, for presentation with search results in response to a search query, for example. To this end, the system can apply such signals as the terms of the search query, the terms associated with the landing page of a content provider (or particular sections of the landing page), various contextual signals, etc. Further, the system in some cases can synthesize content rather than modify content for presentation on behalf of a third party.

In an example implementation, a method for generating custom content responsive to a received search query includes receiving, via a communication interface from a user computing device, a search query including one or more search terms; determining, using one or more processors and responsive to the search query, a set of search results relevant to the search query; identifying, using one or more processors and responsive to the search query, third-party content and/or a third party relevant to the search query; generating, using one or more processors and based on (i) the search query and (ii) the third-party content or the third party, custom content relevant to the search query and related to a landing page associated with the third-party content or the third party, for presentation along with the set of research results; and transmitting, via the communication interface to the user computing device, the custom content.

In another example implementation, an apparatus includes a network interface configured to receive, from a user computing device, a search query including one or more search terms; one or more processors; and one or more non-transitory computer-readable storage media storing computer-readable instructions. The instructions, when executed by the one or more processors, cause the apparatus to: determine, responsive to the search query, a set of search results relevant to the search query; identify, responsive to the search query, third-party content and/or a third party relevant to the search query; generate, based on (i) the search query and (ii) the third-party content or the third party, custom content relevant to the search query and related to a landing page associated with the third-party content or the third party, for presentation along with the set of research results; and transmit, via the network interface to the user computing device, the custom content.

In yet another example implementation, an apparatus includes a network interface configured to receive, from a user computing device, a search query including one or more search terms; a search engine, and a content modification engine. The search engine is configured to: determine, responsive to the search query, a set of search results relevant to the search query; and identify, responsive to the search query, third-party content and/or a third party relevant to the search query. The content modification engine is configured to generate, based on (i) the search query and (ii) the third-party content or the third party, custom content relevant to the search query and related to a landing page associated with the third-party content or the third party, for presentation along with the set of research results. The network interface is further configured to transmit the custom content to the user computing device.

### BRIEF DESCRIPTION OF THE DRAWINGS

The accompanying figures, where like reference numerals refer to identical or functionally similar elements throughout the separate views, together with the detailed description below, are incorporated in and form part of the disclosure, and serve to further illustrate implementation of concepts that include the claimed invention, and explain various principles and advantages of those implementations.

FIG. 1A is a block diagram that illustrates example dynamic generation of content according to the techniques of this disclosure;

FIG. 1B is a block diagram of an example system in which techniques or methods for dynamically generating custom content responsive to a received search query may be implemented, according to an implementation.

FIG. 2 is a block diagram of an example machine learning model for dynamically generating custom content, according to an implementation.

FIG. 3 is a flowchart of an example method that may be implemented by the system of FIG. 1 for generating custom content responsive to a received search query, according to an implementation.

FIG. 4 is a block diagram of an example computing system for implementing example methods and/or operations disclosed herein, according to an implementation.

The apparatus and method components have been represented where appropriate by conventional symbols in the drawings, showing only those specific details that are pertinent to understanding implementations so as not to obscure the disclosure with details that will be readily apparent to those of ordinary skill in the art having the benefit of the description herein.

### DETAILED DESCRIPTION

As discussed in more detail below, responsive to a search query received from a user of a user computing device, a search engine may also identify and select third-party content based on its relevancy to the search query, dynamically modify the third-party content, and return selected third-party content (e.g., in the form of text, multimedia, links to text or multimedia, etc.) to the user computing device for presentation to the user, alongside other search results. Example third-party content includes an advertisement (“ad”), search ad (e.g., an ad chosen and returned responsive to a received search query), a shopping ad, an ad presented or provided within an application, and an ad targeted to a site, content, or advertiser.

The term “third party” will be used herein to distinguish a party (e.g., a seller of coffee, an advertiser, a firm offering professional services, etc.) from a person issuing a search query using a user computing device (e.g., to find or buy coffee, looking for services, etc.). The term third party will also be used herein to distinguish them from another party or entity associated with providing search results and/or custom content responsive to a received search query. For clarity of description, the term “third-party content” will be used herein to refer to any content (e.g., an ad) that a third party, or another party on their behalf, provides that may be, for example, returned by a search engine in response to a search query. Third-party content is content that existed prior to receipt of a search query. Moreover, for clarity of description, the term “landing page content” will be used herein to refer to any content of any landing page(s) associated with a third party. In various examples, third-party content may include a link to a landing page of the third party associated with the third-party content. Furthermore, for clarity of description, the term “custom content” will be used herein to refer to content that is dynamically generated responsive to a search query. That is, custom content is content generated when a search query is received and based on the search query. As described herein, custom content can refer to (i) third-party content that has been modified, as described herein, in some way responsive to a received search query; or (ii) new content that was generated, as described herein, responsive to a received search query and based on landing page content, for example. While custom content can include or represent third-party content, it is referred to herein as custom content to more clearly distinguish it from any third-party content that existed prior to receipt of a search query.

A third party, or another party on their behalf, may generate or create third-party content based on (i) items, services, information, etc. that they are selling, offering, etc. and (ii) potential search queries of potential customers or clients that may be relevant to the third party's offerings. Today, third-party content is created or generated offline, and not generated responsive to a received search query. In some instances, such as a small-to-medium sized business (SMB), they may have limited personnel or limited access to technology for generating or creating third-party content.

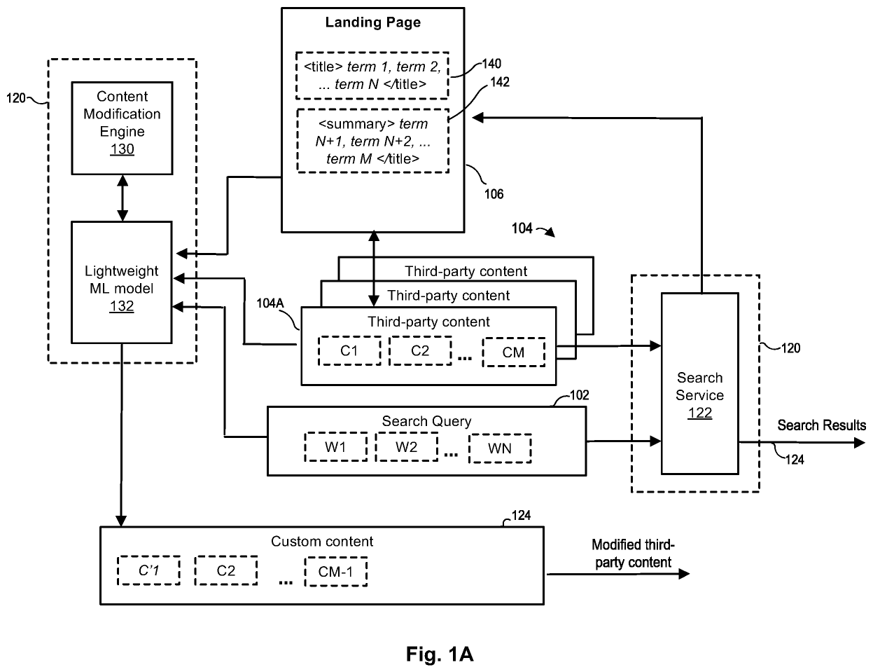

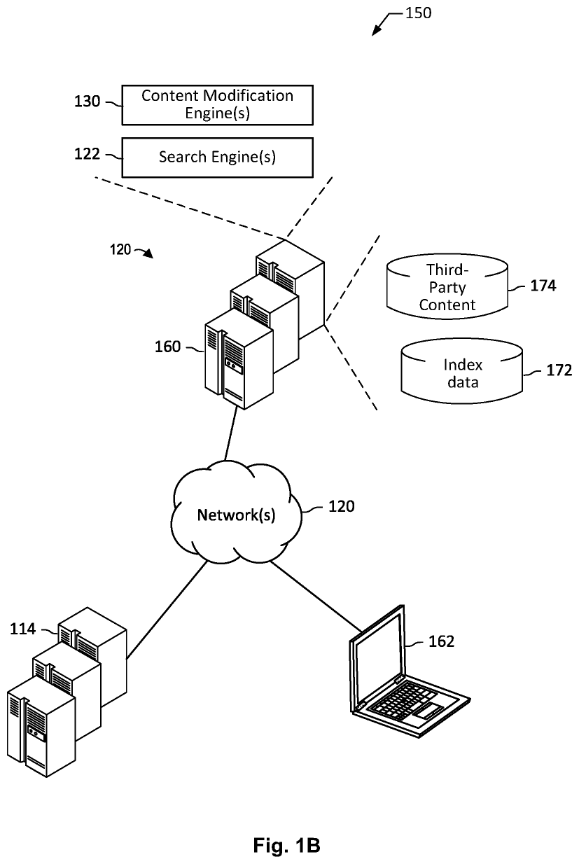

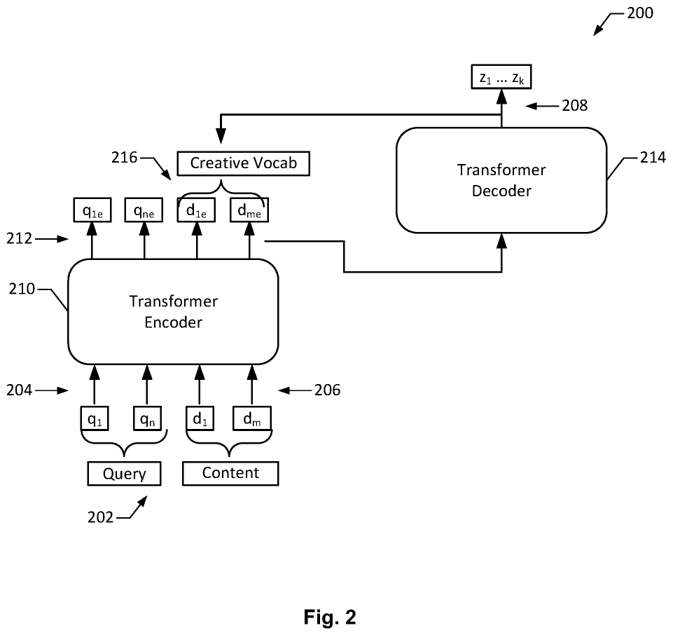

Referring to FIG. 1A, a search query 102 can include one or more words W₁, W₂, . . . W_{N}. Although the techniques of this disclosure generally can apply to individual words, phrases made up of multiple individual words, or other suitable types of semantic units, for simplicity, the examples below refer primarily to standalone words, such as “dark” or “chocolate.” Operating on sequences of words using tokenization techniques is discussed in more detail with reference to FIG. 2.

The search query 102 may be relevant to third-party content 104A, which also can include, or be associated with, one or more words C₁, C₂, . . . C_{M}. The third-party content 104A can be for example an ad, or a textual component of a multimedia ad, that links to a landing page 106 via a uniform resource locator (URL), or another suitable identifier. The party that controls the landing page 106 (e.g., a vendor) can generate the content 104A and provide the content 104A to a system 120 that implements a search engine 122, for display via client devices along with the results 124 to the search query 102.

In some scenarios, the party associated with the landing page 106 provides the one or more words C₁, C₂, . . . C_{M}, or various combinations of these words, as “building blocks,” from which the third-party content 104A may be automatically created offline, prior to, or independent from, a search query 102. In some examples, a human operator such as the vendor associated with the landing page 106 may manually approve or reject such automatically generated content 104A. The system 120 in any case generates the third-party content 104A based only on the set of words {C₁, C₂, . . . C_{M}}.

The system 120 can apply various models to quantitatively assess the relationship between such sequences as {W₁, W₂, . . . W_{N}} and {C₁, C₂, . . . C_{M}}, and determine that the third-party content 104A is relevant to the search query 102. However, the user who issues the search query 102 may not recognize the relevance of the third-party content 104A to the search query 102. It may not be technically or economically feasible for the party associated with the landing page 106 to generate a large number of variants of the content 104A to align with all possible search queries that all potential users may issue.

For example, an advertiser selling various kinds of gourmet chocolate may write the text portion of the content 104A using the phrase “gourmet chocolate” (C₁=“gourmet” and C₂=“chocolate”). However, a certain user may search more specifically for “dark gourmet chocolate” (W₁=“dark”, W₂=“gourmet”, and W₃=“chocolate”). Because the third-party content 104A only mentions gourmet chocolate, but does not specifically mention dark gourmet chocolate, a person may not recognize the relevance of the third-party content 104A and choose not to navigate to the landing page 106, even though the party associated with the landing page 106 in fact sells dark gourmet chocolate. As discussed in more detail below, the system 120 dynamically generates custom content 124 and provides the custom content 124 to the client device that issues the search query 102, along with the search results 124.

In this example scenario, the custom content 124 is based on the third-party content 104A, but here word C′₁ replaces word C₁. The system 120 in this example also omits word C_{M} from the third-party content 104A. More generally, the system 120 can add, replace, modify, etc. any suitable number, including possibly all, of the words, modify the grammatical form of one or more words, re-arrange the words in a sentence, etc. In some implementations, the content modification engine 130 may be configured with a relatively small set of operands such as add, replace, or delete.

As a more specific example, the search service 122 can receive a search query “dark gourmet chocolate” and, in addition to a set of search results, identify the following third-party content (in this case, an ad) as being potentially relevant to the search query:

buy gourmet chocolate online
http://joeschocolate.com

The content modification engine 130 can generate custom content in the form of another ad such as:

buy dark gourmet chocolate online
http://joeschocolate.com

Thus, in this scenario, the content modification engine 130 automatically inserts the word “dark,” so that the custom content is more directly relevant to the received search query of “gourmet dark chocolate.”

The system 120 in at least some of the implementations uses a content modification engine 130 that trains and applies a “lightweight” machine learning (ML) model 132. The ML model 132 can output the custom content 124 based on such input signals as the search query 102, the third-party content 104A (which the search engine 122 or another suitable component of the system 102 identifies as being relevant to the search query 102), the landing page 106, etc. The signals in some implementations also can include one or more of user preferences, user's current location, past transactions associated with the user, etc.

In some cases, the content modification engine 130 generates input vectors for the ML model 132 in view of the location of a word on the landing page 106. More specifically, the content modification engine 130 can assign one weight to the words in the title 140, another, lower weight to the words used in the summary section, and an even lower weight to the words used in the body of the landing page 106. In general, the content modification engine 130 can use any suitable weighting scheme with any suitable topology of the landing page.

The content modification engine 130 in some implementations generates custom content 124 that is not based on the third-party content 104. Rather, the content modification engine 130 can utilize the terms of the search query 102 and such signals as the words included in the landing page 106 to generate content to effectively generate new content on behalf of the third party. The content modification engine 130 can store a set of templates for generating such content (e.g., “buy <term1> at <address>), or the ML model 132 can generate these templates based on such inputs as other available third-party content for the same landing page, or content submitted by the same third party for other websites (in the example above, the third party can operate a website for distributing chocolate and another website for distributing coffee, and the example ad above related to chocolate can serve as a basis for generating new content related to coffee, for the other corresponding website).

In at least some of these implementations, the content modification engine 130 may request manual confirmation from the third party to deploy the automatically generated custom content.

In various implementations, the system 102 can utilize the content modification engine 130 at different stages of selecting third-party content for display with the search results. The system 102 can initially select third-party content in the form of potentially relevant ads based on the search query 102. The system 102 then scores these potentially relevant ads using various signals (which can be related to preferences, geography, historical data, etc.), and ranks the potentially relevant ads based on the generated scores to determine a relatively small subset for display via the client device that originated the search query 102. In one example implementation, the system 102 utilizes the content modification engine 130 after the selection of potentially relevant ads, prior to scoring. The content modification engine 130 in this case can impact the scoring. In another implementation, the system 102 utilizes the content modification engine 130 after the scoring, and thus the content modification engine 130 does not impact the scoring. More generally, the content modification engine 130 can operate at any stage of the third-party content selection process, with or without impact on the scoring.

Although the system 102 can generate a relatively large amount of custom content similar to the content 124 offline for a large number of possible search queries, the number of possible combinations requires a large amount of storage space and a significant amount of computational resources. Further, this approach requires that the system 102 then consider and score a larger number of potentially relevant ads in real time, which results in longer processing time.

In the examples of FIGS. 2-4, the content modification engine 130 operates in substantially real time. In other words, the content modification engine 130 can generate custom content “on the fly,” between a first time when a search query was received, and a second time at which a user and/or user computing device reasonably or normally expects to receive search results relevant to the search query. For example, the content modification engine 130 can generate the custom content 124 within tens of microseconds, or in any case with low latency.

Further, although the system 120 can utilize a complex ML model (e.g., having 200 million or more parameters), this ML model generally operates slower and requires significant amounts of processing and memory resources. In one implementation, the lightweight ML model 132 is orders of magnitude less complex (e.g., having only 300,000 to 3 million parameters, or even fewer parameters), and orders of magnitude faster (e.g., returning custom content within tens of microseconds). Thus, the lightweight ML model 132 is both technically easier to implement and is suitable for operation in conjunction with the low-latency search server 122. The techniques of this disclosure therefore allow a system to efficiently and accurately provide third-party content in response to an electronically received search query, without introducing excessive latency and/or without using excessive computing resources.

Further reference will now be made in detail to non-limiting implementations, some of which are illustrated in the accompanying drawings.

FIG. 1B illustrates an example computing environment 150 in which the system 120 of FIG. 1A can be implemented. The example system 120 includes one or more servers 160 configured to implement the search engine 122 and the content modification engine 130 discussed above. When implemented as multiple units, the servers 160 can be distributed geographically in any suitable manner. A client device 162 that originates the search query 102 can be for example a laptop, a notebook, a mobile device, a smart phone, a tablet, a desktop computer, a Chromebook™ computer or notebook, an augmented reality (AR) device, a virtual reality (VR) device, a mixed reality (MR) device, smart glasses, a server, or any other user computing device.

The one or more servers 160 can access an index database 172 to retrieve search results for a search query (e.g., the results 124 responsive to the search query 102), and a third-party content database 174 to retrieve third-party content such as the content 104. Each of the databases 172 can be implemented in one or more devices equipped with one or more processors and computer-readable non-transitory storage medium. Examples of third-party content that can be stored in the database 174 include a search ad (e.g., an ad chosen and returned responsive to a received search query), a display ad, a shopping ad, an ad presented or provided within an application, or an ad targeted to a site, content, or advertiser. Third-party content may be created using any number and/or type(s) of methods, tools, interfaces, etc., and may be stored using any number and/or type(s) of data structures in any number and/or type(s) of databases, storage media, etc.

As a more specific example, a third party may be a seller of hand-made soap, and the third-party content database 174 may store an ad for lavender soap that includes a link (e.g., a URL) to a website for the third-party at which a person can buy lavender soap and, possibly, other varieties of soap. In operation, the content modification engine 130 can access the landing page of the website and automatically identify the key words such as the words included in the title or summary sections of the landing page (delimited by the corresponding div tags), for example.

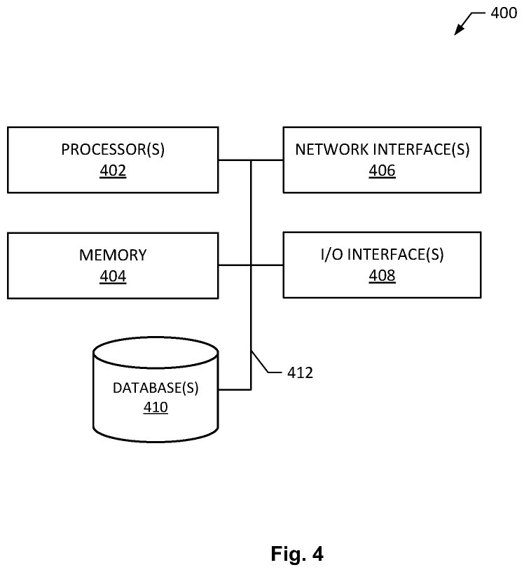

The servers(s) 104 may include any number(s) and/or type(s) of physical server computers and/or virtual, cloud-based servers, which may operate as a server farm, and may include one or more processors, one or more computer memories, and software or computer instructions for generating custom content responsive to a received search query. The software or computer instructions may include one or more modules, programs, portions of programs, etc. for implementing the search engine(s) 106 and/or the content modification engine(s) 108. Alternatively, the search engine(s) 106 and/or the content modification engine(s) 108 may be implemented by software or computer instructions executed by respective servers. An example processing platform 400 that may be used to implement the server(s) 104 is described below in connection with FIG. 4.

A user computing device (e.g., the laptop 110) may include any number and/or type(s) of input devices that a user can use to enter, and submit or issue the search query. For instance, the user may use the input device(s) to enter one or more search terms of a search query into a search interface provided or presented to the user by the user computing device. The search interface may be, for example, part of a website or web browser presented or displayed by the user computing device using any number and/or type(s) of output devices. A search query may include any number and/or types of search terms, or phrases thereof. Example input devices include a virtual keyboard, a physical keyboard, a mouse or other pointing device, and a microphone. For instance, the user may type or speak search terms. The user computing device may present, provide, or display returned search results, third-party content, and/or custom content for the user using the output device(s). Example output devices include a display or a speaker. For instance, search results, third-party content, and/or custom content may be presented as text on a display, or be output by a speaker using text-to-speech translation. The example processing platform 400 of FIG. 4 may also be used to implement a user computing device, such as the laptop 110.

In the depicted example, the server(s) 104, the user computing devices (e.g., the laptop 110), and the server(s) 114 are communicatively coupled or connected, directly or indirectly, via any number and/or type(s) of public and/or private computer networks 120, such as the Internet. In some instances, the server(s) 104, the user computing devices, and/or the server(s) 114 are communicatively coupled to the network(s) 120 via any number and/or type(s) of wired or wireless access networks (not shown for clarity of illustration). For example, the server(s) 104, the user computing devices, and/or the server(s) 114 can be communicatively coupled to the network(s) 120 via any number and/or type(s) of WiFi or cellular base stations. An example cellular base station is implemented in accordance with any number and/or type(s) of communications standards including Global System for Mobile Communications (GSM), Code Division Multiple Access (CDMA), Universal Mobile Telecommunications System (UMTS), Long Term Evolution (LTE), 3G, 4G, or 5G. An example WiFi base station is implemented in accordance with the Institution of Electrical and Electronics Engineers (IEEE) 802.11x family of standards. Additionally and/or alternatively, the server(s) 104, the user computing devices, and/or the server(s) 114 can be communicatively coupled to the network(s) 120 via any number and/or type(s) of wired interfaces, such as an Ethernet interface, or a wired broadband Internet access interface. However, the server(s) 104, the user computing devices, and/or the server(s) 114 can be communicatively coupled in any other ways, including any type(s) of input/output interfaces, such as a universal serial bus (USB) interface, a near-field communication (NFC) interface, or a Bluetooth® interface.

The databases 112, 116, and 118 may be stored using any number and/or type(s) of records, entries, data structures, etc. on any number and/or type(s) of non-transitory computer- or machine-readable storage media. Example storage media include a hard disk drive (HDD), a solid-state drive (SSD), a flash drive, a compact disc (CD), a digital versatile disk (DVD), a Blu-ray disk, a cache, a flash memory, a read-only memory (ROM), a random access memory (RAM), or any other storage device or storage disk associated with a processor in which information may be stored for any duration (e.g., for extended time periods, permanently, for brief instances, for temporarily buffering, and/or for caching).

FIG. 2 is a block diagram of an example ML model 200 that may be used to implement the lightweight ML model 132 and/or the content modification engine 130 of FIGS. 1A and 1B. In the depicted example, the ML model 200 is a sequence-to-sequence ML model whose inputs 202 include (i) terms of a search query 204 (e.g., words q₁ . . . qₙ), and (ii) content 206 (e.g., words d₁ . . . dₘ of third-party content and/or landing page content, or one or more aspects thereof); and whose outputs represent custom content 208 (e.g., words z₁ . . . zₖ) generated responsive to receipt of the search query. The ML model 200 generally transforms a first input sequence of the words of the content 206 into a second output sequence of words of the custom content 208. The first and second sequences do not necessarily have the same length. Depending on the input 202 and/or the training of the ML model 200, the generated custom content 208 may be the same as, or different from, the content 206. For example, there may not be a difference when the system 120 determines that the third-party content is well-aligned with a search query. In some embodiments, the ML model 200 determines whether to use or return the custom content 208 based on, for example, natural language processing (NLP) to determine readability or completeness, its relevance to the search query, whether it contains words or phrases not found in the third-party content and/or on landing page content, etc.

In some implementations, the ML model 200 is not constrained to include at least a portion of third-party content, such that the ML model 200 may change the entirety of the third-party content, may change a majority of the third-party content, and/or generate new custom content 208. In some implementations, when third-party content is not provided or available as input 206 for the ML model 200, the ML model 200 can generate new custom content 208 based on the query 204 and landing page content of the content 206. In some implementations, the ML model 200 may be constrained to limit modifications to third-party content to the insertion, deletion, or substitution of words.

The example ML model 200 includes an example transformer encoder 210 configured and trained to map the input 202 into a sequence of representations or tokens 212 that is fed into an example transformer decoder 214, which is configured and trained to generate the custom content 208 based on the sequence of tokens 212.

The example encoder 210 is configured and trained to tokenize the input words 202 into tokens 212 that include words, parts of words, etc. The encoder 210 can tokenize based on a sub-word vocabulary (e.g., using a word-piece or sentence-piece tokenizer), a word vocabulary, a character vocabulary, and/or a byte vocabulary, for example.

The example decoder 214 is configured and trained to create the custom content 208 using, for example, a pointing mechanism (e.g., a pointer network) to select and output tokens from the tokens 212. The decoder 214 continues to create the custom content 208 until, for example, a special end symbol is generated. The special end symbol may be generated based on, for example, detecting that the custom content 208 output thus far represents a complete sentence, or some other condition is satisfied.

In some implementations, the decoder 214 is configured to select tokens only from a creative vocabulary 216 that is associated with the content 206, that is, third-party content and/or landing page content. Thus, reducing the possibility of so-called machine-generated hallucinations, which are machine-generated content that does not exist in the content 206. However, in some implementations, the creative vocabulary 216 is expanded to also include tokens that are considered to be always safe (e.g., determiners, antecedents, prepositions, punctuation, etc.). Alternatively, the decoder 214 could select from any of the tokens 212, and the ML model 200 could discard any generated custom content 208 that includes content outside third-party content and/or landing page content. However, in some implementations, the decoder 214 may not restrict the creative vocabulary 216 to the third-party content and/or landing page content by training the decoder 214 to reduce the risk of hallucinations. In some implementations, so-called cross attention is implemented. The decoder 214 in this case may be auto-regressive, and predict one token at a time while taking previously predicted tokens into consideration to predict a future token or word. Additionally and/or alternatively, the decoder 214 may be non-auto-regressive, and predict the tokens simultaneously, possibly in multiple stages where at each stage the output is an improvement over a previous stage.

The decoder 214 may edit third-party content in steps (e.g., deleting, followed by inserting, followed by reorder, etc.). However, as discussed above with reference to FIG. 1A, operations of the decoder 214 do not have to be restricted to editing third-party content. Instead, the decoder 214 may generate custom content 208 that does not have any overlap with third-party content.

In some implementations, the encoder 210 and decoder 214 or, more generally, the ML model 200 do not implement recurrence or convolutions to generate their respective outputs 212, 208. The ML model 200 may be, or additionally include, a classification model configured and trained for determining whether to insert, swap, delete, etc. words of the pre-existing third-party content to generate custom content. Other ML models and/or ML architectures that may also be used to implement, or be included in, the ML model 200 include, but are not limited to, a recursive neural network (RNN), a long short-term memory (LSTM) model, a convolutional neural network (CNN), a hybrid architecture (e.g., a transformer encoder with an RNN decoder), and/or a non-auto-regressive transformer (e.g., which outputs tokens all at once).

An ML model training module comprised of machine-readable and machine-executable instructions can be used to configure, parameterize, initialize, and/or train the ML model 200, and store the ML model 200 as machine-readable instructions on an HDD, an SSD, a flash drive, a CD, a DVD, a Blu-ray disk, a cache, a flash memory, a ROM, a RAM, or any other storage device or storage disk that may be associated with one or more processors (e.g., the processor 402 of FIG. 4) in which information may be stored for any duration (e.g., for extended time periods, permanently, for brief instances, for temporarily buffering, and/or for caching), and coupled to the one or more processors to provide access to the machine-readable instructions stored thereon. The machine-readable instructions can be executed by one or more processors (e.g., the processor 402) to implement the ML model 300.

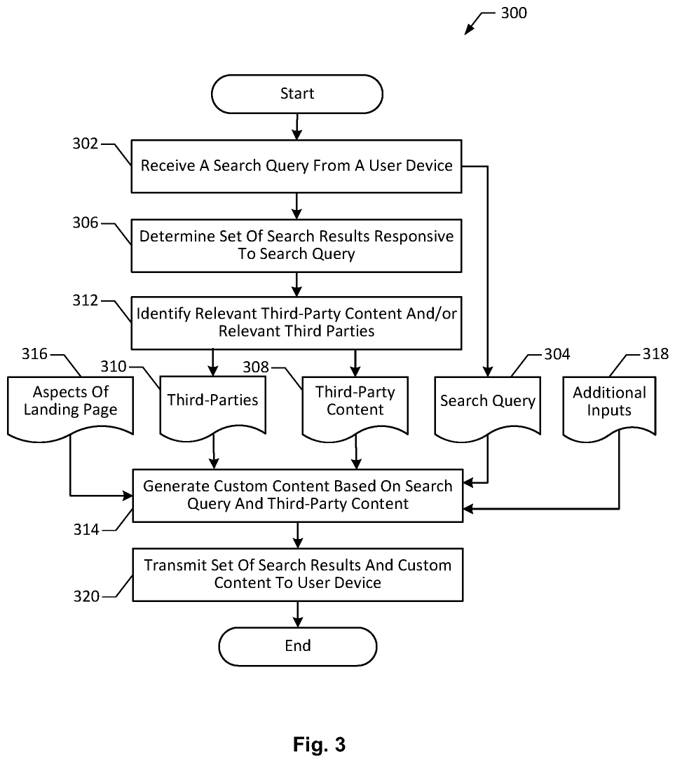

FIG. 3 is a flowchart of an example method 300, hardware logic, machine-readable instructions, or software for generating custom content responsive to a received search query, as disclosed herein. Any or all of the blocks of FIG. 3 may be an executable program or portion(s) of an executable program embodied in software and/or machine-readable instructions stored on a non-transitory, machine-readable storage medium for execution by one or more processors such as the processor 402 of FIG. 4. Additionally and/or alternatively, any or all of the blocks of FIG. 3 may be implemented by one or more hardware circuits structured to perform the corresponding operation(s) without executing software or instructions.

The method 300 starts at block 302, when a search query 304 is received from a user computing device (e.g., the laptop 110). A search engine 106 determines, as described above in connection with FIG. 1A, a set of one or more search results relevant to the search query (block 304), and identifies and selects third-party content 308 and/or one or more third parties 310 based on their relevancy to the search query (block 312).

A content modification engine 108 generates, as described above in connection with FIGS. 1A-2, custom content relevant to the search query 304 (block 314). For example, the content modification engine 108 can generate custom content by modifying, in part or in whole, the third-party content 308. Additionally and/or alternatively, the content modification engine 108 can generate new custom content for the third party 310. The content modification engine 108 can, for example, generate custom content based on one or more of (i) one or more search terms of the search query 304, (ii) the third-party content 308, (iii) one or more aspects of landing page content 316, and/or (iv) additional inputs 318, such as user characteristics, third-party metadata, etc.

The search engine 106 returns (e.g., transmits) the search results, third-party content, and/or the custom content to the user computing device (block 320). In some examples, the search engine 106 selects and returns custom content from the custom content generated by the content modification engine 108 based on their relevancy to the search query 304.

FIG. 4 is a block diagram of an example processing platform 400 capable of implementing, for example, one or more components of, or all of, the example search engine(s) 106, the content modification engine(s) 108, the ML model 200, and/or, more generally, the server(s) 104 of FIGS. 1A-2. The processing platform 400 may also be used to implement user computing devices, such as the laptop 110. The example processing platform 400 is capable of executing machine-readable instructions to, for example, implement operations, logic, techniques, etc. of example methods described herein, as may be represented, for example, by any flowcharts of the drawings that accompany this description.

The example processing platform 400 of FIG. 4 includes a processor 402 such as, for example, one or more microprocessors, controllers, and/or any suitable type of processor. Example processors include one or more programmable processors, one or more microprocessors, one or more controllers, one or more graphics processing units (GPUs), one or more digital signal processors (DSPs), one or more microcontroller units (MCUs), one or more hardware accelerators, one or more special-purpose computer chips, and one or more system-on-a-chip (SoC) devices.

The example processing platform 400 of FIG. 4 includes memory (e.g., volatile memory, non-volatile memory, a ROM, a RAM, a flash memory, a cache, etc.) 404 accessible by the processor 402 (e.g., via a memory controller). The example processor 402 interacts with the memory 404 to obtain, for example, machine-readable instructions stored in the memory 404 corresponding to, for example, the operations, logic, techniques, etc. disclosed herein and/or represented by flowcharts of this disclosure. Additionally or alternatively, machine-readable instructions corresponding to the example operations, logic, techniques, etc. described herein may be stored on an HDD, an SSD, a flash drive, a CD, a DVD, a Blu-ray disk, or any other storage device or storage disk that may be associated with the processor 402 in which information may be stored for any duration (e.g., for extended time periods, permanently, for brief instances, for temporarily buffering, and/or for caching), and coupled to the processing platform 400 to provide access to the machine-readable instructions stored thereon.

Additionally and/or alternatively, operations, logic, techniques, etc. disclosed herein may be implemented by one or more logic circuits without executing software. Example logic circuits include field programmable gate arrays (FPGAs) and application specific integrated circuits (ASICs).

The example processing platform 400 of FIG. 4 includes one or more communication interfaces such as, for example, one or more network interface 406, and/or one or more input/output (I/O) interfaces 408. The communication interface(s) enable the processing platform 400 of FIG. 4 to communicate with, for example, another device, system, server, etc. (e.g., to receive a search query from a user computing device, and/or transmit search results, third-party content, and custom content to the user computing device), datastore, database, and/or any other machine.

The example processing platform 400 of FIG. 4 includes the network interface(s) 406 to enable communication with other machines (e.g., to receive a search query from a user computing device, and/or transmit search results, third-party content, and custom content to the user computing device) via, for example, one or more networks, such as the network(s) 120. The example network interface 406 includes any suitable type of communication interface(s) (e.g., wired and/or wireless interfaces) configured to operate in accordance with any suitable communication protocol(s). Example network interfaces 406 include a TCP/IP interface, a WiFi™ transceiver (e.g., according to the IEEE 802.11x family of standards), an Ethernet transceiver, a cellular network radio, a satellite network radio, or any other suitable interface based on any other suitable communication protocols or standards.

The example, processing platform 400 of FIG. 4 includes the input/output (I/O) interface(s) 408 (e.g., a Bluetooth® interface, a near-field communication (NFC) interface, a universal serial bus (USB) interface, a serial interface, an infrared interface, etc.) to enable receipt of user input (e.g., a touch screen, keyboard, mouse, touch pad, joystick, trackball, microphone, button, etc.) and communication of output data (e.g., search results, third-party content, custom content, etc.) to the user (e.g., via a display, speaker, printer, etc.).

The above description refers to block diagrams of the accompanying drawings. Alternative implementations of the examples represented by block diagrams include one or more additional and/or alternative elements, processes, and/or devices. Additionally and/or alternatively, one or more of the example blocks of the diagrams may be combined, divided, re-arranged, and/or omitted. Components represented by the blocks of the diagrams are implemented by hardware, software, firmware, and/or any combination of hardware, software and/or firmware.

Although the foregoing Detailed Description sets forth a detailed description of numerous different aspects, examples, and implementations of the disclosure, it should be understood that the scope of the patent is defined by the words of the claims set forth at the end of this patent. The Detailed Description is to be construed as exemplary only and does not describe every possible implementation because describing every possible implementation would be impractical, if not impossible. In the foregoing Detailed Description, it can be seen that various features are grouped together in various implementations for the purpose of streamlining the disclosure. This method of disclosure is not to be interpreted as reflecting an intention that the claims require more features than are expressly recited in each claim. Rather, as the following claims reflect, inventive subject matter may lie in less than all features of a single disclosed implementation. Thus, the following claims are hereby incorporated into the Detailed Description, with each claim standing on its own as a separately claimed subject matter. Numerous alternative implementations could be implemented, using either current technology or technology developed after the filing date of this patent, which would still fall within the scope of the claims. The disclosure herein contemplates at least the following examples:

Throughout this disclosure, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example implementations may be implemented as a combined structure or component. Similarly, structures and functionality presented as a single component may be implemented as separate components. For example, a process, method, article, or apparatus that comprises a list of elements is not necessarily limited to only those elements but may include other elements not expressly listed or inherent to such process, method, article, or apparatus. These and other variations, modifications, additions, and improvements fall within the scope of the subject matter of the present disclosure.

Unless expressly stated to the contrary, “or” refers to an inclusive or and not to an exclusive or. For example, “A, B or C” refers to any combination or subset of A, B, C such as (1) A alone, (2) B alone, (3) C alone, (4) A with B, (5) A with C, (6) B with C, and (7) A with B and with C. As used herein, the phrase “at least one of A and B” is intended to refer to any combination or subset of A and B such as (1) at least one A, (2) at least one B, and (3) at least one A and at least one B. Similarly, the phrase “at least one of A or B” is intended to refer to any combination or subset of A and B such as (1) at least one A, (2) at least one B, and (3) at least one A and at least one B.

Use of “a” or “an” are employed to describe elements and components of the implementations herein. This is done merely for convenience and to give a general sense of the description. This description, and the claims that follow, should be read to include one or at least one and the singular also includes the plural unless it is obvious that it is meant otherwise.

The term “coupled” as used herein is defined as connected, although not necessarily directly and not necessarily mechanically. A device or structure that is “configured” in a certain way is configured in at least that way, but may also be configured in ways that are not listed.

Unless specifically stated otherwise, discussions in the disclosure using words such as “processing,” “computing,” “calculating,” “determining,” “presenting,” “displaying,” “selecting,” “identifying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, each of the terms “tangible machine-readable medium,” “non-transitory machine-readable medium,” “machine-readable medium” or variants thereof is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium,” “machine-readable medium” or variants thereof is expressly defined to exclude propagating signals. That is, as used in any claim of this patent, none of the terms “tangible machine-readable medium,” “non-transitory machine-readable medium,” “machine-readable medium” or variants thereof can be read to be implemented by a propagating signal.

As used in the disclosure, the terms “substantially,” “essentially,” “approximately,” “about,” “generally” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%.

As used in the disclosure, any reference to “one implementation,” “an implementation,” “one aspect,” “an aspect,” etc. means that a particular element, feature, structure, or characteristic described in connection with the implementation, example, etc. is included in at least one implementation, example, etc. The appearances of the phrases “in one implementation,” “in some implementations,” “one aspect,” “an aspect,” etc. in various places in the specification are not necessarily all referring to the same implementation(s).

The Abstract is provided to allow the reader to quickly ascertain the nature of the technical disclosure. It is submitted with the understanding that it will not be used to interpret or limit the scope or meaning of the claims.

The benefits, advantages, solutions to problems, and any element(s) that may cause any benefit, advantage, or solution to occur or become more pronounced are not to be construed as a critical, required, or essential features or elements of any or all the claims.

Unless a claim element is defined by reciting the word “means” and a function without the recital of any structure, it is not intended that the scope of any claim element be interpreted based on the application of 35 U.S.C. § 112(f)

Upon reading this disclosure, those of skill in the art will appreciate still additional alternative structural and functional designs for facilitating indoor navigation through the disclosed principles in the present disclosure. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation, and details of the method and apparatus disclosed in the present disclosure without departing from the spirit and scope defined in the appended claims.

Although certain example methods, apparatus, systems, and articles of manufacture have been disclosed herein, the scope of coverage of this patent is not limited thereto. On the contrary, this patent covers all methods, apparatus, systems, and articles of manufacture fairly falling within the scope of the claims of this patent.

1. A method for generating custom content responsive to a received search query, the method comprising:
receiving, via a communication interface from a user computing device, a search query including one or more search terms;
determining, using one or more processors and responsive to the search query, a set of search results relevant to the search query;
identifying, using one or more processors and responsive to the search query, third-party content and/or a third party relevant to the search query;
generating, using one or more processors and based on (i) the search query and (ii) the third-party content or the third party, custom content relevant to the search query and related to a landing page associated with the third-party content or the third party, for presentation along with the set of search results; and
transmitting, via the communication interface to the user computing device, the custom content.

2. The method of claim 1, wherein generating the custom content includes:
forming an input vector including (i) one or more search terms of the search query; and (ii) at least a portion of the third-party content and/or information related to the third party; and
processing the input vector with one or more configured and trained machine learning models to determine the custom content.

3. The method of claim 2, wherein the input vector further includes one or more aspects of the landing page.

4. The method of claim 2, wherein the input vector further includes one or more user characteristics.

5. The method of claim 1, wherein generating the custom content includes:
generating, responsive to the search query, all of the custom content.

6. The method of claim 1, wherein generating the custom content includes:
determining one or more modifications to the third-party content based on one or more search terms of the search query, and at least a portion of the third-party content; and
modifying the third-party content based on the one or more modifications to form the custom content.

7. The method of claim 6, wherein determining the one or more modifications includes:
forming an input vector including the one or more search terms of the search query, and the at least a portion of the third-party content; and
processing the input vector with one or more configured and trained machine learning models to determine the one or more modifications.

8. The method of claim 7, wherein the input vector further includes one or more aspects of the landing page, and/or one or more user characteristics.

9. The method of claim 6, wherein the one or more modifications include at least one of an inserted word, an inserted phrase, a deleted word, a deleted phrase, a replacement word, a replacement phrase, a modified word, or a modified phrase.

10. The method of claim 6, wherein the one or more modifications include a rewrite of one or more portions of the identified third-party content.

11. The method of claim 1, further comprising:
transmitting, via the communication interface to the user computing device, the set of search results, wherein the custom content is generated before the set of search results are transmitted to the user computing device.

12. The method of claim 1, wherein generating the custom content includes:
including in the custom content substantially only words from the third-party content or the landing page.

13. The method of claim 1, wherein the custom content comprises a customized search advertisement.

14. The method of claim 1, further comprising:
processing landing page content with one or more configured and trained machine learning models to determine the one or more aspects of the landing page.

15. The method of claim 1, wherein the one or more aspects of the landing page were determined prior to receipt of the search query.

16. An apparatus, comprising:
a network interface configured to receive, from a user computing device, a search query including one or more search terms;
one or more processors; and
one or more non-transitory computer-readable storage media storing computer-readable instructions that, when executed by the one or more processors, cause the apparatus to:
determine, responsive to the search query, a set of search results relevant to the search query;
identify, responsive to the search query, third-party content and/or a third party relevant to the search query;
generate, based on (i) the search query and (ii) the third-party content or the third party, custom content relevant to the search query and related to a landing page associated with the third-party content or the third party, for presentation along with the set of search results; and
transmit, via the network interface to the user computing device, the custom content.

17. The apparatus of claim 16, wherein the instructions, when executed by the one or more processors, cause the apparatus to:
form an input vector including (i) one or more search terms of the search query; and (ii) at least a portion of the third-party content and/or information related to the third party; and
process the input vector with one or more configured and trained machine learning models to determine content for the custom content.

18. The apparatus of claim 17, wherein the input vector further includes one or more aspects of the landing page.

19. The apparatus of claim 17, wherein the input vector further includes one or more user characteristics.

20. The apparatus of claim 16, wherein the instructions, when executed by the one or more processors, cause the apparatus to generate the custom content by generating, responsive to the search query, all of the custom content.

21. The apparatus of any of claim 16, wherein the instructions, when executed by the one or more processors, cause the apparatus to generate the custom content by:
determining one or more modifications to the third-party content based on one or more search terms of the search query, and at least a portion of the third-party content; and
modifying the third-party content based on the one or more modifications to form the custom content.

22. An apparatus, comprising:
a network interface configured to receive, from a user computing device, a search query including one or more search terms;
a search engine configured to:
determine, responsive to the search query, a set of search results relevant to the search query; and
identify, responsive to the search query, third-party content and/or a third party relevant to the search query; and
a content modification engine configured to:
generate, based on (i) the search query and (ii) the third-party content or the third party, custom content relevant to the search query and related to a landing page associated with the third-party content or the third party, for presentation along with the set of search results,
wherein the network interface is configured to transmit the custom content to the user computing device.

23. The apparatus of claim 22, wherein the content modification engine is configured to:
form an input vector including (i) one or more search terms of the search query; and (ii) at least a portion of the third-party content and/or information related to the third party; and
process the input vector with one or more configured and trained machine learning models to determine the custom content.

24. The apparatus of claim 23, wherein the input vector further includes one or more aspects of the landing page.

25. The apparatus of claim 23, wherein the input vector further includes one or more user characteristics.

26. The apparatus of claim 22, wherein the content modification engine is configured to generate the custom content by generating, responsive to the search query, all of the custom content.

27. The apparatus of claim 22, wherein the content modification engine is configured to generate the custom content by:
determining one or more modifications to the third-party content based on one or more search terms of the search query, and at least a portion of the third-party content; and
modifying the third-party content based on the one or more modifications to form the custom content.
